(19) United States
(12) Patent Application Publication
(10) Pub. No.: US 2020/0073591 A1
(43) Pub. Date: Mar. 5, 2020

(54) FLASH MEMORY CONTROLLER AND ASSOCIATED ACCESSING METHOD AND ELECTRONIC DEVICE

(71) Applicant: RayMX Microelectronics, Corp., Anhui province (CN)

(72) Inventors: Han-Ting Tsai, Taipei City (TW); Yen-Chung Chen, Hsinchu County (TW); Yufeng Zhou, Ningbo City (CN); Bo-Cheng Chiang, Taipei City (TW)

(21) Appl. No.: 16/175,792

(22) Filed: Oct. 30, 2018

(30) Foreign Application Priority Data
Sep. 4, 2018 (CN) 201811028072.1

(51) Int. Cl. G06F 3/06; G06N 5/02

(52) U.S. Cl. CPC G06F 3/0659; G06N 5/02; G06F 3/0679; G06F 3/0604

(57) ABSTRACT

The present invention provides a flash memory controller including an artificial intelligence (AI) module and a microprocessor. In the operations of the flash memory controller, the AI module receives data from a host device, and determines if the data is hot data or cold data to generate a determination result. The microprocessor is configured to selectively write the data into a first block or a second block within a flash memory module according to the determination result, wherein quantity of bits stored in each memory cell within the first block is different from quantity of bits stored in each memory cell within the second block.

### BACKGROUND OF THE INVENTION

### 1. Field of the Invention

The present invention relates to a flash memory controller.

### 2. Description of the Prior Art

When original data of a flash memory module needs to be updated, a flash memory controller writes updated data whose logical address is the same as that of the original data into another physical address of the flash memory module, and the original data stored in the flash memory module becomes invalid data. Therefore, if the flash memory module stores the data that is accessed and updated by an operating system frequently (i.e. the data is regarded as hot data), because the data is constantly updated and written into different physical addresses of the flash memory module, the data written into the flash memory module becomes invalid in a short time. Therefore, garbage collections are performed more often to release the memory space, a write amplification factor of the data within the flash memory module is increased, and life of the flash memory module is influenced.

In addition, the flash memory module may have one or more types of blocks such as single-level cell (SLC) blocks, multi-level cell (MLC) blocks, triple-level cell (TLC) blocks and/or quadruple-level cell (QLC) blocks, where the TLC blocks and the QLC blocks have larger storage capacity and shorter life. Therefore, if the above-mentioned hot data that is updated frequently is stored in the TLC block or QLC block, the TLC block or the QLC block will have much invalid data that may trigger the garbage collection operation to move the valid data to another block and erase all of the contents within the original block to release the memory space. Because the TLC/QLC block has much smaller erase count or smaller program/erase cycle (P/E cycle), this frequent erase operations may worsen the life of the flash memory module.

### SUMMARY OF THE INVENTION

It is therefore an objective of the present invention to provide a flash memory controller, which can determine that if data that is to be written into the flash memory module is hot or cold, and write the hot data and the cold data into the appropriate blocks, to solve the above-mentioned problems.

In a first embodiment of the present invention, a flash memory controller comprising an artificial intelligence (AI) module and a microprocessor is disclosed. In the operations of the flash memory controller, the AI module receives data from a host device, and determines if the data is hot data or cold data to generate a determination result. The microprocessor is configured to selectively write the data into a first block or a second block within a flash memory module according to the determination result, wherein quantity of bits stored in each memory cell within the first block is different from quantity of bits stored in each memory cell within the second block.

In a second embodiment of the present invention, a method for accessing a flash memory module is disclosed, wherein the method comprises the steps of: receiving data from a host device; determining if the data is hot data or cold data to generate a determination result; selectively writing the data into a first block or a second block within a flash memory module according to the determination result, wherein quantity of bits stored in each memory cell within the first block is different from quantity of bits stored in each memory cell within the second block.

In a third embodiment of the present invention, an electronic device comprising a flash memory module and a flash memory controller is disclosed, wherein the flash memory controller comprising an AI module and a microprocessor is disclosed. In the operations of the flash memory controller, the AI module receives data from a host device, and determines if the data is hot data or cold data to generate a determination result. The microprocessor is configured to selectively write the data into a first block or a second block within a flash memory module according to the determination result, wherein quantity of bits stored in each memory cell within the first block is different from quantity of bits stored in each memory cell within the second block.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating an electronic device according to one embodiment of the present invention.

FIG. 2 shows different types of blocks within the flash memory module.

FIG. 3 is a flowchart of a method for accessing the flash memory module according to one embodiment of the present invention.

### DETAILED DESCRIPTION

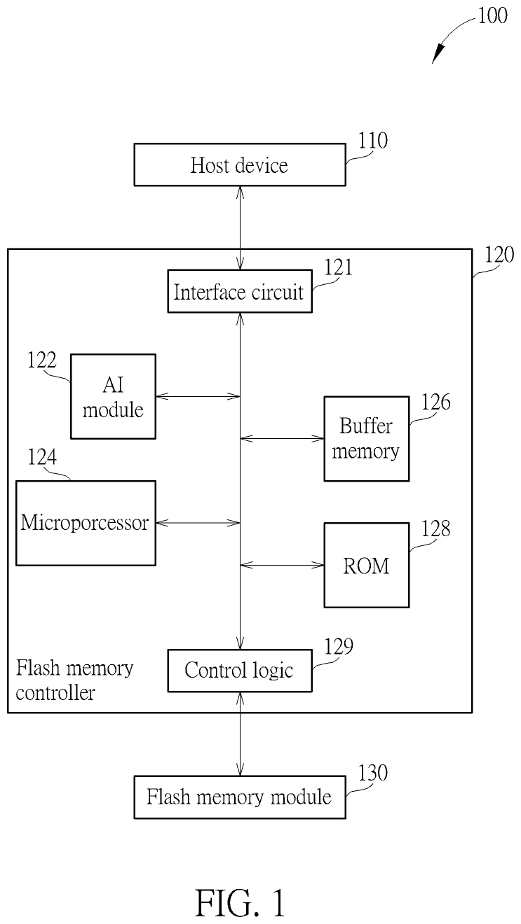

FIG. 1 is a diagram illustrating an electronic device 100 according to one embodiment of the present invention. As shown in FIG. 1, the electronic device 100 comprises a host device 110, a flash memory controller 120 and a flash memory module 130, where the flash memory controller 120 comprises an interface circuit 121, an AI module 122, a microprocessor 124, a buffer memory 126, a read only memory (ROM) 128 and a control logic 129. The ROM 128 is used to store program codes, and the microprocessor 124 is configured to execute the program codes to control the access of the flash memory module 130, and the elements within the flash memory controller 120 may communicate with each other via buses shown in FIG. 1. In this embodiment, the flash memory controller 120 and the flash memory module 130 can be regarded as a solid-state drive (SSD), the electronic device 100 can be any computer or server having the SSD, and the host device 110 can be a processor configured to access the flash memory module 130 via the flash memory controller 120.

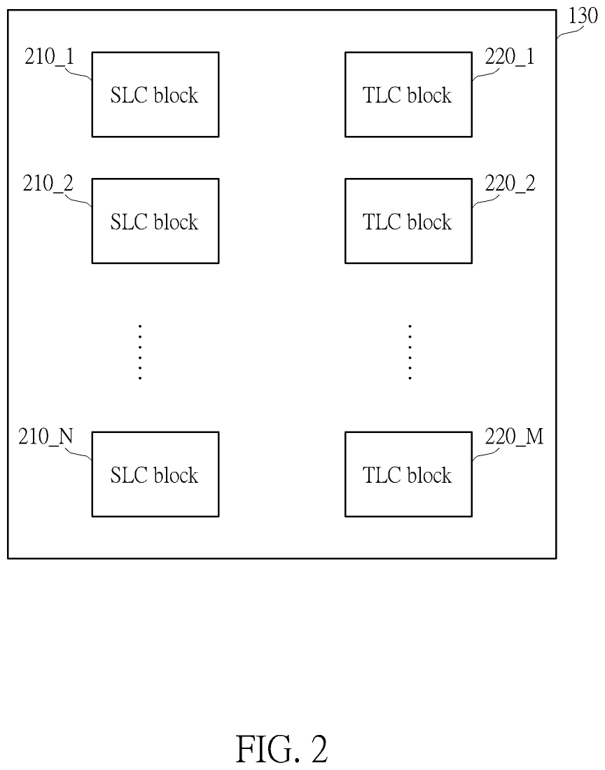

The flash memory module 130 comprises at least one flash memory chip, each flash memory chip comprises a plurality blocks, each block comprises a plurality of pages. In the designs of the flash memory, each block is a minimum erasing unit, that is all the data within the block must be erased together, and only deleting a portion of the data of the block is not allowed. In addition, each page is a minimum writing unit. In addition, the flash memory module 130 comprises a plurality of first blocks with longer life and a plurality of second blocks with shorter life. For the convenience of the following descriptions, the first blocks are SLC blocks 210_1-210_N, and the second blocks are TLC blocks 220_1-220_M shown in FIG. 2, where each memory cell (e.g. a floating gate transistor) of the SLC blocks 210_1-210_N is used to store only one bit, and each memory cell of the TLC blocks 220_1-220_M can be used to store three bits. Because the write characteristics of the SLC blocks 210_1-210_N and the TLC blocks 220_1-220_M, the allowable erase count or P/E cycle of the TLC blocks 220_1-220_M is much less than the allowable erase count or P/E cycle of the SLC blocks 210_1-210_N, that is the TLC blocks 220_1-220_M have shorter life.

In the operations of the electronic device 100, when the host device 110 needs to write data into the flash memory module 130, the host device 110 transmits a write command and the data to the interface circuit 121 of the flash memory controller 120. Then, the AI module 122 determines if the data belongs to hot data or cold data to generate a determination result, wherein the hot data means that the data is updated frequently such as the data of the operating system or file system, and the cold data means that the data is updated infrequently such as video data, photo, and file etc. Then, the microprocessor 124 refers to the determination result to selectively write the data into the SLC blocks 210_1-210_N or the TLC blocks 220_1-220_M. Specifically, if the determination result indicates that the data is the hot data, microprocessor 124 directly writes the data into the SLC blocks 210_1-210_N via an encoder and a randomizer within the control logic 129. If the determination result indicates that the data is the cold data, microprocessor 124 writes the data into the TLC blocks 220_1-220_M via the control logic 129.

In light of above, the hot data updated frequently is directly stored into the SLC blocks 210_1-210_N having longer life and more allowable erase count, therefore, most of the data stored in the SLC blocks 210_1-210_N are the hot data, and these hot data will be updated and becomes invalid accordingly. Because the storage capacity of each of the SLC blocks 210_1-210_N is less than the TLC block, if the flash memory controller 120 performs the garbage collection operations upon the SLC blocks 210_1-210_N later, the amount the valid data required to be moved is decreased (compared with the TLC blocks 220_1-220_M), and the write amplification factor will be decreased to extend the life of the flash memory module 130. In addition, because the cold data updated infrequently is directly written into the TLC blocks 220_1-220_M having shorter life but greater storage capacity, so the space of the flash memory module 130 can be used efficiently.

In one embodiment, the AI module 122 refers to a write frequency of the data to determine if the data belongs to the hot data or the cold data. For example, the AI module 122 may calculate the write frequency according to a write count of a logical address corresponding to the data within a past period of time (e.g. several hours or one day), and determines that the data is hot if the write frequency of the data is greater than a threshold, and determines that the data is cold if the write frequency of the data is not greater than the threshold. In another embodiment, the AI module 122 may refer to the logical address of the data to determine if the data is hot or cold. For example, if the logical address of the data is within some ranges, the AI module 122 determines that the data is the hot data; otherwise, the AI module 122 determines that the data is the cold data. In addition, the AI module 122 may refer to a type of the data to determine if the data belongs to the hot data or the cold data. For example, if the amount of the data is minimum amount transmitted by the host device 110 (e.g. 4 kilobyte), the AI module 122 determines that the data is hot; otherwise, the AI module 122 determines that the data is cold.

In one embodiment, the AI module 122 is trained to determine a plurality of decision logics when the flash memory controller 120 is in an off-line state, and the AI module 122 uses the plurality of decision logics to determine if the data belongs to the hot data or cold data to generate the determination result when the flash memory controller 120 is in an on-line state. For example, when the flash memory controller 120 is in the off-line state (i.e. the flash memory controller 120 does not connect to the flash memory module 130 yet), engineers can input the simulated system data or other hot data into the AI module 122 for the training operations to determine a portion of the decision logics, where the portion of the decision logics may be the threshold of the write frequency for determining the hot data, and/or characteristics of the logic addresses of the hot data, and/or the type of the hot data, and/or the data amount distribution of the hot data. Similarly, the engineers may input the simulated photo, video data or other cold data into the AI module 122 for the training operations to determine another portion of the decision logics, where the portion of the decision logics may be the threshold of the write frequency for determining the cold data, and/or characteristics of the logic addresses of the cold data, and/or the type of the cold data, and/or the data amount distribution of the cold data.

It is noted that the SLC blocks 210_1-210_N and the TLC blocks 220_1-220_M included in the flash memory module 130 shown in FIG. 2, and the microprocessor 124 refers to the determination result of the AI module 122 to write the hot data and the cold data into the SLC blocks 210_1-210_N and the TLC blocks 220_1-220_M, respectively in the embodiment are for illustrative purposes only. In other embodiments of the present invention, the flash memory module 130 can comprise at least two types of blocks including the SLC blocks, MLC blocks, TLC blocks and QLC blocks, and the microprocessor 124 refers to the determination result of the AI module 122 to write the hot data into the blocks whose memory cell stores less bits, and write the cold data into the blocks whose memory cell stores more bits. For example, if the flash memory module 130 comprises the MLC blocks (i.e. each memory cell stores two bits) and the SLC blocks, the microprocessor 124 will write the hot data and the cold data into the SLC blocks and the MLC blocks, respectively, according to the determination result of the AI module 122. As another example, if the flash memory module 130 comprises the SLC blocks, the MLC blocks and the QLC blocks (i.e. each memory cell stores four bits), the microprocessor 124 can refer to the determination result of the AI module 122 to write the hot data into the QLC blocks, and write the cold data into the SLC blocks and/or MLC blocks. As another example, if the flash memory module 130 comprises the SLC blocks, the MLC blocks and the QLC blocks, the microprocessor 124 can refer to the determination result of the AI module 122 to write the hot data into the QLC blocks and the MLC blocks, and write the cold data into the SLC blocks.

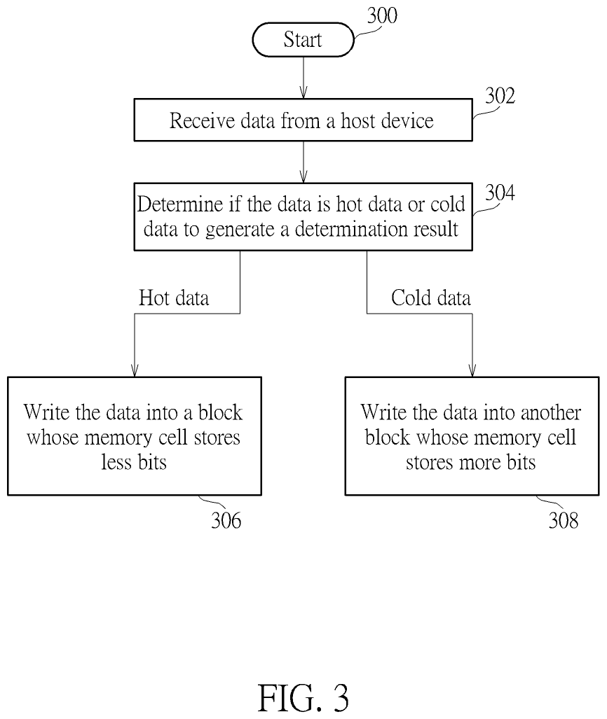

FIG. 3 is a flowchart of a method for accessing the flash memory module 130 according to one embodiment of the present invention. Refer to FIG. 1, FIG. 2 and the above disclosure, the flow is described as follows.

Step 300: the flow starts.

Step 302: receive data from a host device.

Step 304: determine if the data is hot data or cold data to generate a determination result. When the determination result indicates that the data is the hot data, the flow enters Step 306; and if the determination result indicates that the data is the cold data, the flow enters Step 308.

Step 306: write the data into a block whose memory cell stores less bits.

Step 308: write the data into another block whose memory cell stores more bits.

Briefly summarized, in the flash memory controller of the present invention, the AI module is provided to determine if the data from the host device is hot or cold, and the microprocessor refers to the determination result of the AI module to write the hot data into the block whose memory cell stores less bits (e.g. SLC block), and write the cold data into the block whose memory cell stores more bits (e.g. TLC block). By using the embodiments of the present invention, the life of the flash memory module can be extended.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A flash memory controller, comprising:
an artificial intelligence (AI) module, for receiving data from a host device, and determining if the data is hot data or cold data to generate a determination result; and
a microprocessor, coupled to the AI module, for determining to write the data into a first block or a second block of a flash memory module according to the determination result, wherein quantity of bits stored in each memory cell within the first block is different from quantity of bits stored in each memory cell within the second block.

2. The flash memory controller of claim 1, wherein when the determination result indicates that the data is the hot data, the microprocessor writes the data into the first block of the flash memory module; and when the determination result indicates that the data is the cold data, the microprocessor writes the data into the second block of the flash memory module, wherein the quantity of bits stored in each memory cell within the first block is lower than the quantity of bits stored in each memory cell within the second block.

3. The flash memory controller of claim 2, wherein the first block is a single-level cell (SLC) block, the second block is a multi-level cell (MLC) block; or the first block is the SLC block or the MLC block, and the second block is a triple-level cell (TLC) block or a quadruple-level cell (QLC) block.

4. The flash memory controller of claim 1, wherein the AI module refers to a write frequency of the data to determine if the data is the hot data or the cold data, to generate the determination result.

5. The flash memory controller of claim 4, wherein if the write frequency of the data is greater than a threshold value, the AI module determines that the data is the hot data; and if the write frequency of the data is not greater than the threshold value, the AI module determines that the data is the cold data.

6. The flash memory controller of claim 4, wherein the AI module determines if a write count of a logical address corresponding to the data within a past period of time is greater than a threshold value, to determine if the data is the hot data or the cold data, to generate the determination result.

7. The flash memory controller of claim 1, wherein the AI module determines if the data belongs to the hot data or the cold data according to a logical address of the data, to generate the determination result.

8. The flash memory controller of claim 1, wherein the AI module is trained to determine a plurality of decision logics in an off-line state of the flash memory controller, and the AI module uses the plurality of decision logics to determine if the data is the hot data or the cold data to generate the determination result in an on-line state of the flash memory controller.

9. A method for accessing a flash memory module, comprising:
receiving data from a host device;
determining if the data is hot data or cold data to generate a determination result; and
determining to write the data into a first block or a second block of a flash memory module according to the determination result, wherein quantity of bits stored in each memory cell within the first block is different from quantity of bits stored in each memory cell within the second block.

10. The method of claim 9, wherein the step of determining to write the data into the first block or the second block of the flash memory module according to the determination result comprises:
when the determination result indicates that the data is the hot data, writing the data into the first block of the flash memory module; and
when the determination result indicates that the data is the cold data, writing the data into the second block of the flash memory module, wherein the quantity of bits stored in each memory cell within the first block is lower than the quantity of bits stored in each memory cell within the second block.

11. The method of claim 10, wherein the first block is a single-level cell (SLC) block, the second block is a multi-level cell (MLC) block; or the first block is the SLC block or the MLC block, and the second block is a triple-level cell (TLC) block or a quadruple-level cell (QLC) block.

12. The method of claim 9, wherein the step of determining if the data is the hot data or the cold data to generate the determination result comprises:
referring to a write frequency of the data to determine if the data is the hot data or the cold data, to generate the determination result.

13. The method of claim 12, wherein the step of referring to the write frequency of the data to determine if the data is the hot data or the cold data to generate the determination result comprises:
if the write frequency of the data is greater than a threshold value, determining that the data is the hot data; and
if the write frequency of the data is not greater than the threshold value, determining that the data is the cold data.

14. The method of claim 12, wherein the step of referring to the write frequency of the data to determine if the data is the hot data or the cold data to generate the determination result comprises: determining if a write count of a logical address corresponding to the data within a past period of time is greater than a threshold value, to determine if the data is the hot data or the cold data, to generate the determination result.

15. The method of claim 9, wherein the step of determining if the data is the hot data or the cold data to generate the determination result comprises:
determining if the data belongs to the hot data or the cold data according to a logical address of the data, to generate the determination result.

16. The method of claim 9, wherein the method is executed by a flash memory controller, and the method comprises the steps of:
determining a plurality of decision logics in an off-line state of the flash memory controller; and
the step of determining if the data is the hot data or the cold data to generate the determination result comprises:
using the plurality of decision logics to determine if the data is the hot data or the cold data to generate the determination result in an on-line state of the flash memory controller.

17. An electronic device, comprising:
a flash memory module; and
a flash memory controller, for accessing the flash memory module, wherein the flash memory controller comprises:
an artificial intelligence (AI) module, for receiving data from a host device, and determining if the data is hot data or cold data to generate a determination result; and
a microprocessor, coupled to the AI module, for determines to write the data into a first block or a second block of the flash memory module according to the determination result, wherein quantity of bits stored in each memory cell within the first block is different from quantity of bits stored in each memory cell within the second block.

18. The electronic device of claim 17, wherein when the determination result indicates that the data is the hot data, the microprocessor writes the data into the first block of the flash memory module; and when the determination result indicates that the data is the cold data, the microprocessor writes the data into the second block of the flash memory module, wherein the quantity of bits stored in each memory cell within the first block is lower than the quantity of bits stored in each memory cell within the second block.

19. The electronic device of claim 18, wherein the first block is a single-level cell (SLC) block, the second block is a multi-level cell (MLC) block; or the first block is the SLC block or the MLC block, and the second block is a triple-level cell (TLC) block or a quadruple-level cell (QLC) block.

20. The electronic device of claim 17, wherein the AI module refers to a write frequency of the data to determine if the data belongs to the hot data or the cold data, to generate the determination result.
